(19) United States
(12) Patent Application Publication
(10) Pub. No.: US 2023/0189764 A1
(43) Pub. Date: Jun. 22, 2023

(54) NOVEL RIVET-TYPE HUMMINGBIRD FEEDER BASE

(71) Applicant: Hangzhou Green Vine Trading Co., Ltd., Hangzhou (CN)

(72) Inventor: Cuifeng Shen, Yancheng (CN)

(21) Appl. No.: 17/573,673

(22) Filed: Jan. 12, 2022

(30) Foreign Application Priority Data
Dec. 16, 2021 (CN) 2021231712205

(51) Int. Cl. A01K 39/02

(52) U.S. Cl. CPC A01K 39/0206

(57) ABSTRACT

Disclosed is a novel rivet-type hummingbird feeder base, which comprises a basin body and an upper cover, wherein the top of the upper cover is provided with a through hole for assembling a nectar bottle, and the upper cover is provided with a plurality of groups of florets and perches for attracting hummingbirds; a group of florets and perches are riveted and connected to the upper cover through a hollow rivet, the middle part of the hollow rivet forms a suction hole for the hummingbird's tongue to pass through, the basin body is connected with the upper cover by a buckle, and a sealing ring is arranged between the basin body and the upper cover; the hollow rivet is made of copper that has a high toughness, a high strength and conforms to environmental protection standards; the wall thickness of the nail rod is 0.7 mm, and the cross section of the annular nail cap is a solid rectangle, and the outer side of the upper opening is made into a circular arc; the perch and the floret are riveted and connected by hollow rivets, the structure of the feeder base is optimized, the perch is firmer, the welding process is not needed, and the assembly is simplified. Through the optimized design of the material and size of the hollow rivet, it is ensured that the hollow rivet does not deform in case of riveting and extruding, the inner wall of the orifice is smooth and burr-free, and the hummingbird will not cut the tongue when sipping water.

### TECHNICAL FIELD

The present utility model relates to a novel rivet-type hummingbird feeder base.

### BACKGROUND

Birds play an important role in maintaining ecological balance and protecting green plants in nature. Protecting birds means protecting the future of mankind, and the concept of environmental protection is recognized by the world. Hummingbirds are the smallest birds in the world, and all hummingbirds have been listed in the Red List of Endangered Species of the World Conservation Union. Hummingbirds are mainly distributed in South America, Central America and southern part of North America. People living there have been getting along with hummingbirds all the time. More and more people like to buy hummingbirds feeders to hang in the gardens around villas to provide hummingbirds with drinking water and nectar.

Common hummingbird feeders in the market generally consist of a glassy nectar bottle and a metal base, wherein the base consists of a basin body and an upper cover, and the edge of the upper cover is welded with a plurality of perches for hummingbirds to stand on. Because the upper cover and perches are thin-walled parts, the connection of the perches is not very reliable due to the butt-welding method, and perches tend to fall off during actual uses. There are also several florets on the cover, and the hollow rivets are riveted at the flower core of the florets to form a suction hole for hummingbirds to sip water. Because the wall thickness of the hollow rivet rod and the nail cap of the suction hole of the feeder in the market at present is very thin (only 0.16 mm), and the cross section of the annular nail cap is a thin plate hollow circular arc, and the toughness of the material is insufficient, severe cracking deformation is likely to occur during riveting and extrusion, and sharp burrs will be formed on the inner wall of the suction hole, therefore, when hummingbirds stick their tongues into the suction hole to sip water, they are easily stabbed by those sharp burrs and cut themselves.

### SUMMARY

Aiming at the shortcomings in the above problems, the present utility model provides a novel rivet-type hummingbird feeder base.

In order to achieve the above purpose, the utility model provides a novel rivet-type hummingbird feeder base, comprising a basin body and an upper cover connected to an upper part of the basin body, wherein a top of the upper cover is provided with a through hole for assembling a nectar bottle, and the upper cover is provided with a plurality of groups of florets and perches for attracting hummingbirds, characterized in that a group of the florets and the florets are riveted and connected to the upper cover through a hollow rivet, a middle part of the hollow rivet forms a suction hole for the hummingbird's tongue to pass through;

the perch and the floret are riveted and connected by hollow rivets, the structure of the feeder base is optimized, the perch is firmer, the welding process is not needed, and the assembly is simplified.

As a further improvement of the solution, the basin body and the upper cover are connected by a buckle, and a sealing ring is also arranged between the basin body and the upper cover;

in the above technical solution, the buckling connection mode is convenient for disassembly and cleaning, and the sealing ring is arranged at the top of the basin body to play a watertight role.

As a further improvement of the solution, the hollow rivet has an inner diameter of 2.3 mm and an outer diameter of 5.5 mm; the hollow rivet is made of a copper material that has a high toughness and a strength, and conforms to environmental protection standards; a wall thickness of a nail rod is 0.7 mm, and a cross section of an annular nail cap is a solid rectangle, and the outer side of an upper opening is made into an a circular arc.

In the above technical solution, the size optimization of the hollow rivet can effectively prevent bees from burrowing into the feeder base; the hollow rivet is made of a copper material with high toughness and strength and meeting the environmental protection standards, the wall thickness of the nail rod is thickened from 0.16 mm to 0.7 mm, and the cross section of the annular nail cap is a solid rectangle (2.25 mm in width and 1.5 mm in height), and the outer side of the upper opening is made into an a circular arc, which ensures that the hollow rivet is not deformed during riveting and extrusion, and the inner wall of the orifice is smooth and burr-free so that the hummingbirds do not cut their tongues when sipping water.

Compared with the prior art, the utility model has the beneficial effects that: the perch and the floret are riveted and connected by hollow rivets, the structure of the feeder base is optimized, the perch is firmer, the butt-welding process is not needed, and the assembly is simplified; Through the optimized design of the material and size of the hollow rivet, it is ensured that the hollow rivet will not deform during riveting and extrusion, the inner wall of the orifice will be smooth and burr-free, and the hummingbird will not cut the bird's tongue when sipping water.

### BRIEF DESCRIPTION OF DRAWINGS

FIG. 1 is a perspective view of the upper cover of a novel rivet-type hummingbird feeder base of the present utility model;

FIG. 2 is a sectional view of the upper cover in FIG. 1;

FIG. 3 is an enlarged view of the position A in FIG. 2.

in which 1. Upper cover; 11. Through hole; 2. Floret; 3. Hollow rivet; 31. Suction hole; 4. Perch.

### DESCRIPTION OF EMBODIMENTS

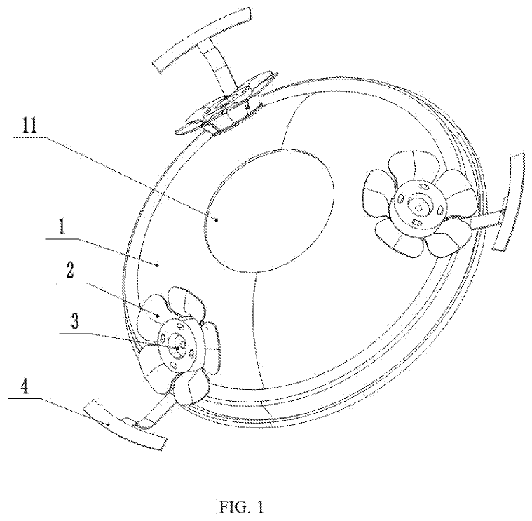

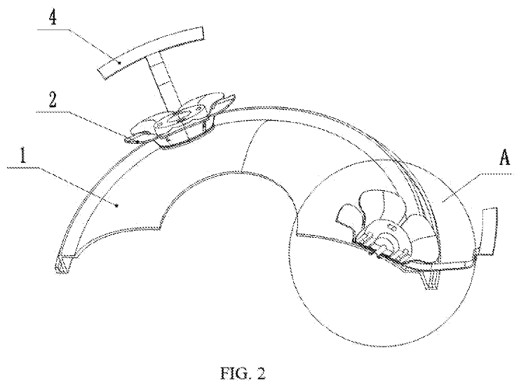

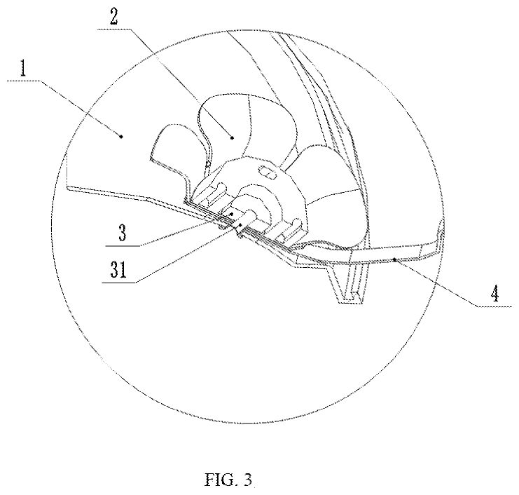

As shown in FIG. 1, FIG. 2 and FIG. 3, a novel rivet-type hummingbird feeder base according to the embodiment of the utility model comprises a basin body and an upper cover 1 connected to the upper part of the basin body; the top of the upper cover 1 is provided with a through hole 11 for assembling nectar bottles; the upper cover 1 is provided with a plurality of groups of florets 2 and perches 4 for attracting hummingbirds; a group of florets 2 and perches 4 are riveted and fixedly connected to the upper cover 1 through a hollow rivet 3, and the middle of the hollow rivet 3 is formed for the hummingbird tongue to pass through, wherein, the basin body is connected with the upper cover 1 by a buckle, and a sealing ring is also arranged between the basin body and the upper cover 1, and buckling connection is convenient for disassembly and cleaning; the sealing ring is arranged at the top of the basin body to play a watertight role; the hollow rivet 3 has an inner diameter of 2.3 mm and an outer diameter of 5.5 mm. By optimizing the size of the hollow rivet, bees can be effectively prevented from burrowing into the feeder base. The hollow rivet 3 is made of a copper material with high toughness and strength and conforming to the environmental protection standards; the wall thickness of the nail rod is 0.7 mm; the cross section of the annular nail cap is a solid rectangle and the outer side of the upper opening is made into a circular arc. The hollow rivet is made of a copper material with high toughness and strength, and conforming to the environmental standards. The wall thickness of the nail rod is thickened from 0.16 mm to 0.7 mm, the cross section of the annular nail cap is a solid rectangle (2.25 mm wide and 1.5 mm high), and the outer side of the upper opening is made into a circular arc, which ensures that the hollow rivet is not deformed during riveting and extrusion, the inner wall of the orifice is smooth and burr-free, and the hummingbird does not cut the bird tongue when sipping water.

The perch and the floret are riveted and connected by hollow rivets, the structure of the feeder base is optimized, the perch is firmer, the welding process is not needed, and the assembly is simplified; through the optimized design of the material and size of the hollow rivet, it is ensured that the hollow rivet will not deform during riveting and extrusion, the inner wall of the orifice will be smooth and burr-free, and the hummingbird will not cut the bird's tongue when sipping water.

The above description is only the preferred embodiment of the present utility model, and is not intended to limit the present utility model. For those skilled in the field, the utility model can be modified and changed in various ways. Any modification, equivalent replacement, improvement and the like made within the spirit and principle of the present utility model shall be included in the scope of protection of the present utility model.

What is claimed is:

1. A novel rivet-type hummingbird feeder base, comprising a basin body and an upper cover (1) connected to an upper part of the basin body, wherein a top of the upper cover (1) is provided with a through hole (11) for assembling a nectar bottle, and the upper cover (1) is provided with a plurality of groups of florets (2) and perches (4) for attracting hummingbirds, characterized in that a group of the florets (2) and the florets (1) are riveted and connected to the upper cover through a hollow rivet (3), a middle part of the hollow rivet forms a suction hole (31) for the hummingbird's tongue to pass through.

2. The novel rivet-type hummingbird feeder base according to claim 1, characterized in that the basin body and the upper cover (1) are connected by a buckle, and a sealing ring is also arranged between the basin body and the upper cover (1).

3. The novel rivet-type hummingbird feeder base according to claim 1, characterized in that the hollow rivet (3) has an inner diameter of 2.3 mm and an outer diameter of 5.5 mm; the hollow rivet (3) is made of a copper material that has a high toughness and a strength, and conforms to environmental protection standards; a wall thickness of a nail rod is 0.7 mm, and a cross section of an annular nail cap is a solid rectangle, and the outer side of an upper opening is made into a circular arc.
